(19) United States
(12) Patent Application Publication
(10) Pub. No.: US 2022/0078742 A1
(43) Pub. Date: Mar. 10, 2022

(54) PROCEDURE TO HANDLE SERVICES PROVIDED BY A UE SUPPORTING MULTIPLE USIM CARD

(71) Applicant: NEC Corporation, Minato-ku, Tokyo (JP)

(72) Inventors: Kundan TIWARI, Tokyo (JP); Toshiyuki TAMURA, Tokyo (JP)

(73) Assignee: NEC Corporation, Minato-ku, Tokyo (JP)

(21) Appl. No.: 17/417,192

(22) PCT Filed: Nov. 15, 2019
(86) PCT No.: PCT/JP2019/044895

§ 371 Date: Jun. 22, 2021

(30) Foreign Application Priority Data
Dec. 28, 2018 (IN) 201841049571

(51) Int. Cl. H04W 60/00

(52) U.S. Cl. CPC H04W 60/005; H04W 88/06

(57) ABSTRACT

This disclosure is related to the procedure to handle the services provided by a UE (100) supporting multiple USIM card (105). More specifically it provides a method for paging co-ordination when a UE (100) is registered to a PLMN for more than two USIM cards (105) separately.

### TECHNICAL FIELD

The present disclosure relates to the procedure to handle services provided by a UE supporting multiple USIM card.

### BACKGROUND ART

A mutli-USIM UE supports multiple registrations to a PLMN for more than one USIM (SUPI) concurrently and providing the services to a user using more than one USIM subscription. A mode of the UE that UE performs registrations to a PLMN for more than one USIM (SUPI) concurrently and providing the services to a user using more than one USIM subscription is also called “multi-mode”. The most used multiple UUSIM (i.e. multi-mode) UEs support either dual receiver and single transmitter or single receiver and dual transmitter. When the multi-mode UE supporting single transceiver (single transmitter and single receiver) establishes connection to a network to avail a service for a UICC (SUPI-1), the UE cannot transmit or receive signalling to get services for another UICC (SUPI-2). For a multiple-USIM UE supporting single transmitter and multi-receiver configuration the UE can receive paging for second UICC while the UE is in connected mode for the first UICC but the UE cannot establish signalling connection to the network for the second UICC and cannot send and receive dedicated signalling for second UICC and cannot avail the services for dual UICC.

### CITATION LIST

### Non Patent Literature

NPL 1: 3GPP TR 21.905, “Vocabulary for 3GPP Specifications”, V15.0.0 (2018-03)
NPL 2: 3GPP TS 23.501, “System Architecture for the 5G System; Stage 2”, V15.2.0 (2018-06)
NPL 3: 3GPP TS 23.502, “Procedures for the 5G System; Stage 2”, V15.2.0 (2018-06)
NPL 4: 3GPP TS 24.501, “Non-Access-Stratum (NAS) protocol for 5G System (5GS) Stage 3”, V15.0.0 (2018-06)

### SUMMARY OF INVENTION

### Technical Problem

Problem Statement 1:

When a multi-USIM UE supports a single transmitter and a receiver and is in connected mode i.e. having a NAS signalling connection for a first UICC card then it is not possible to get MT paging for the second UICC. This will cause a sever service impact for the user when a higher priority MT service related to second UICC is triggered for the user. The user in this scenario will miss the high priority services. For example when a user is in accessing internet using the first UICC and the MT IMS call comes for the second UICC then the user is not able to receive the MT IMS call.

Problem Statement 2:

When a multi-USIM UE supports a single transmitter and a receiver is in connected mode for one UICC. Then the UE cannot transmit any signalling or data message to the network for any other UICC. This will create two issues:

i) In this scenario, when the UE will not able to periodically update it is presence to the network for other UICC.

ii) When an event triggers deregister procedure for a second UICC (e.g. 5G services is disabled for the second UICC or second UICC is removed), then the UE cannot send deregistration message for a second USIM, and the network will keep the UE context for the second UICC. Therefore, when an MT services come for the second UICC then the network may send paging or reserve the network resources (Buffering packet for a service related to the second USIM). In this scenarios when the UE comes to idle mode then it is not clear whether the UE performs deregistration procedure or not.

In view of the problems described above, the present disclosure aims to provide a solution to solve at least one of the various problems.

### Solution to Problem

A method for a network apparatus according to the present disclosure includes receiving, from a User Equipment (UE) that includes a first Universal Subscriber Identity Module (USIM) having a first Subscription Permanent Identifier (SUPI) registered with an Access and Mobility Management Function (AMF) and a second USIM having a second SUPI, a message including a Registration Request for the second SUPI, determining a target AMF based on the Registration Request for the second SUPI, and sending, to the target AMF, a message including the Registration Request for the second SUPI.

A method for a network apparatus according to the present disclosure includes registering a first Subscription Permanent Identifier (SUPI) for a first Universal Subscriber Identity Module (USIM) included in a User Equipment (UE) and a second SUPI for a second USIM included in the UE, receiving, from a Network Function (NF), a message to send a signaling or data to the UE for the second SUPI, and paging the UE to send the signaling or data for the second SUPI.

A method for a User Equipment (UE) according to the present disclosure includes registering with an Access and Mobility Management Function (AMF) a first Subscription Permanent Identifier (SUPI) for a first Universal Subscriber Identity Module (USIM) included in the UE and a second SUPI for a second USIM included in the UE, initiating a UE initiated procedure with the second SUPI, sending, to the AMF, a first message for the second SUPI, performing the UE initiated procedure, and receiving, form the AMF, a second message for the second SUPI.

### BRIEF DESCRIPTION OF DRAWINGS

FIG. 1 illustrates a multi-USIM UE configuration.

FIG. 2 illustrates a registration procedure with NG-RAN performing the steering to a target AMF according to a first aspect.

FIG. 3 illustrates a registration procedure with AMF performing the steering to a target AMF according to a second aspect.

FIG. 4 illustrates another variation, rerouting via NG-RAN, according to the second aspect.

FIG. 5 illustrates a paging procedure in the connected mode according to a third aspect.

FIG. 6 illustrates a paging procedure in the idle mode according to a forth aspect.

FIG. 7 illustrates a UE initiated procedure in the connected mode with other SUPI according to a fifth aspect.

FIG. 8 illustrates a general block diagram for UE.

FIG. 9 illustrates a general block diagram for (R)AN.

FIG. 10 illustrates a general block diagram for AMF.

### DESCRIPTION OF EMBODIMENTS

Multi-USIM UE Configuration

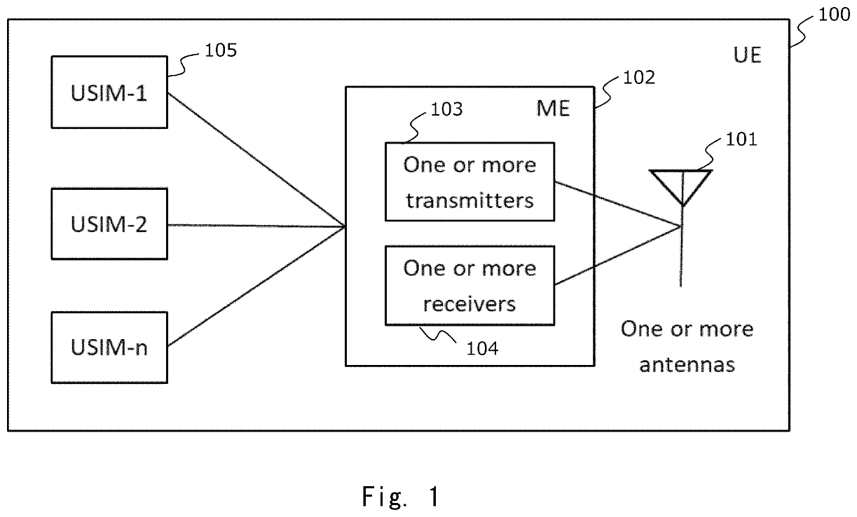

FIG. 1 illustrates a configuration of a multi-USIM UE. As shown, the UE 100 includes one or more antennas 101, a Mobile Equipment (ME) 102 including one or more transmitters 103 and one or more receivers 104, and more than one USIM 105 (USIM-1, USIM-2, USIM-n).

### Abbreviations

For the purposes of the present document, the abbreviations given in NPL 1 and the following apply. An abbreviation defined in the present document takes precedence over the definition of the same abbreviation, if any, in NPL 1.

5GC 5G Core Network

5GS 5G System

5G-AN 5G Access Network

5G-GUTI 5G Globally Unique Temporary Identifier

5G S-TMSI 5G S-Temporary Mobile Subscription Identifier

5QI 5G QoS Identifier

AF Application Function

AMF Access and Mobility Management Function

AN Access Node

AS Access Stratum

AUSF Authentication Server Function

CM Connection Management

CP Control Plane

CSFB Circuit Switched (CS) Fallback

DL Downlink

DN Data Network

DNAI DN Access Identifier

DNN Data Network Name

EDT Early Data Transmission

EPS Evolved Packet System

EPC Evolved Packet Core

FQDN Fully Qualified Domain Name

GFBR Guaranteed Flow Bit Rate

GMLC Gateway Mobile Location Centre

GPSI Generic Public Subscription Identifier

GUAMI Globally Unique AMF Identifier

HR Home Routed (roaming)

I-RNTI I-Radio Network Temporary Identifier

LADN Local Area Data Network

LBO Local Break Out (roaming)

LMF Location Management Function

LRF Location Retrieval Function

MAC Medium Access Control

MFBR Maximum Flow Bit Rate

MICO Mobile Initiated Connection Only

MME Mobility Management Entity

N3IWF Non-3GPP Inter Working Function

NAI Network Access Identifier

NAS Non-Access Stratum

NEF Network Exposure Function

NF Network Function

NG-RAN Next Generation Radio Access Network

NR New Radio

NRF Network Repository Function

NSI ID Network Slice Instance Identifier

NSSAI Network Slice Selection Assistance Information

NSSF Network Slice Selection Function

NSSP Network Slice Selection Policy

PCF Policy Control Function

PEI Permanent Equipment Identifier

PER Packet Error Rate

PFD Packet Flow Description

PLMN Public land mobile network

PPD Paging Policy Differentiation

PPI Paging Policy Indicator

PSA PDU Session Anchor

QFI QoS Flow Identifier

QoE Quality of Experience

(R)AN (Radio) Access Network

RLC Radio Link Control

RM Registration Management

RQA Reflective QoS Attribute

RQI Reflective QoS Indication

RRC Radio Resource Control

SA NR Standalone New Radio

SBA Service Based Architecture

SBI Service Based Interface

SD Slice Differentiator

SDAP Service Data Adaptation Protocol

SEAF Security Anchor Functionality

SEPP Security Edge Protection Proxy

SMF Session Management Function

S-NSSAI Single Network Slice Selection Assistance Information

SSC Session and Service Continuity

SST Slice/Service Type

SUCI Subscription Concealed Identifier

SUPI Subscription Permanent Identifier

UDSF Unstructured Data Storage Function

UICC Universal Integrated Circuit Card

UL Uplink

UL CL Uplink Classifier

USIM Universal Subscriber Identity Module

UPF User Plane Function

UDR Unified Data Repository

URSP UE Route Selection Policy

SMS Short Message Service

SMSF SMS Function

MT Mobile Terminated

UAC Unified Access Control

ODACD Operator Defined Access Category Definitions

OS Operating System

### Definitions

For the purposes of the present document, the terms and definitions given in NPL 1 and the following apply. A term defined in the present document takes precedence over the definition of the same term, if any, in NPL 1.

Aspects

Exemplary aspects now will be described with reference to the accompanying drawings. The disclosure may, however, be embodied in many different forms and should not be construed as limited to the aspects set forth herein; rather, these aspects are provided so that this disclosure will be thorough and complete, and will fully convey its scope to those skilled in the art. The terminology used in the detailed description of the particular exemplary aspects illustrated in the accompanying drawings is not intended to be limiting. In the drawings, like numbers refer to like elements.

It is to be noted, however, that the reference numerals in claims illustrate only typical aspects of the present subject matter, and are therefore, not to be considered for limiting of its scope, for the subject matter may admit to other equally effective aspects.

The specification may refer to “an”, “one” or “some” aspect(s) in several locations. This does not necessarily imply that each such reference is to the same aspect(s), or that the feature only applies to a single aspect. Single features of different aspects may also be combined to provide other aspects.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

First Aspect (Solution 1 to Solve Problem Statement 1 and 2):

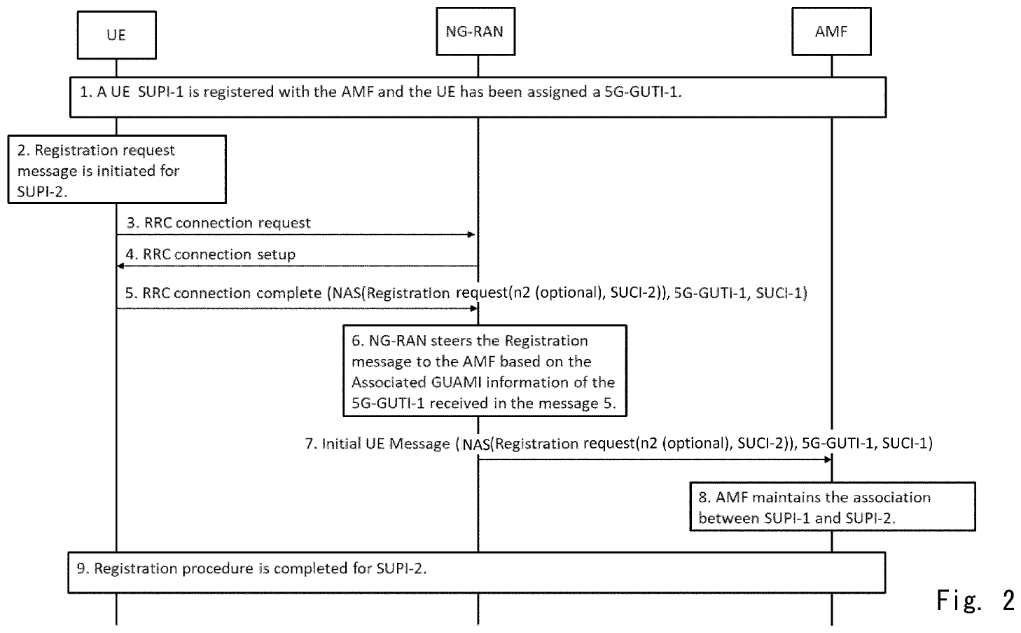

A procedure according to a first aspect includes registering all SUPIs of a UE to a Single AMF with steering done by NG-RAN. FIG. 2 shows the detailed steps of the procedure. The detailed steps of FIG. 2 are described below.

1. A UE is registered for a SUPI-1 to an AMF of a PLMN. The UE has been assigned a 5G-GUTI-1 for the SUPI-1.

In one example, the UE assigns a unique integer number (n1) to SUPI-1 (e.g. USIM Slot number of UICC 1 to SUPI-1). The UE sends the unique integer number assigned to SUPI-1 in a registration request message or in other NAS procedures. The AMF, upon reception of the unique integer number assigned to SUPI-1, associates the SUPI-1 and the unique integer number (n1) and stores it in the UE context for SUPI-1.

2. The UE is in Idle mode i.e. does not have any NAS signalling connection for USIM-1 having SUPI-1 with the AMF. The UE initiates a registration procedure for a second UICC (USIM-2 having SUPI-2).

3. The UE sends the RRC (Connection) Setup request message to an NG-RAN in order to establish an RRC Connection.

4. The NG-RAN sends the RRC (Connection) Setup message to the UE.

5. The UE sends the RRC (Connection) Setup Complete message the NG-RAN, the message including following parameters:

i) Registration Request message for the SUPI-2.

ii) at least one of SUCI of the first UICC 1 (SUCI-1) or 5G-GUTI of the first UICC assigned in step 1 (5G-GUTI-1).

In one example the UE assigns a unique integer number (n2) to SUPI-2 (e.g. USIM Slot number of UICC 2 to SUPI-2). The UE sends the unique integer number assigned n2 to SUPI-2 in registration request message or in other NAS procedure.

6. The NG-RAN determines a target AMF for the Registration Request based on 5G-GUTI-1 or SUCI as follows:

i) If SUCI-1 is included in the RRC setup complete message then the NG-RAN finds the AMF where the UE is currently registered for SUPI-1 using SUCI-1.

In one example the NG-RAN sends SUCI-1 to the UDM or O&M entity to get the identity of the AMF (GUAMI) where the UE is registered for SUPI-1.

ii) If 5G-GUTI-1 is included in the RRC setup complete message then the NG-RAN selects the AMF based on the GUAMI part of the 5G-GUTI-1.

iii) if both SUCI-1 and 5G-GUTI-1 are included then the NG-RAN selects the AMF based on SUCI-1 or 5G-GUTI as described above in step 6 point i) and ii).

7. After selecting the target AMF, the NG-RAN sends the Initial UE message with Registration Request message including SUCI-2 to the selected AMF.

8. On receiving the Initial UE message with Registration Request message and 5G-GUTI-1 or SUCI-1, the AMF processes the registration request message for SUPI-2 and creates a context for SUPI-2. The AMF finds a 5GMM context related to SUPI-1 using 5G-GUTI-1 or SUCI-1. The AMF makes an association between the 5GMM contexts of SUPI-1 and 5GMM Context of SUPI-2 i.e. the 5GMM contexts of SUPI-1 and SUPI-2 are linked each other. In other words, 5GMM context for SUPI-1 contains a pointer to 5GMM contest for SUPI-2 and vice versa. Using 5GMM context of SUPI-1, the 5GMM context of SUPI-2 is fetched and vice versa.

The AMF may also make an association between the 5GMM contexts of SUCI-1 and 5GMM Context of SUCI-2.

The AMF may maintain an association among multiple 5GMM contexts in case where one ME is shared by multiple USIMs.

The AMF associates the SUPI-2 and the unique integer number (n2) and stores it in the UE context for SUPI-2.

9. The AMF completes the registration procedure for SUPI-2.

In one example the AMF assigns a single temporary identity for both SUPI-1 and SUPI-2. In this case, the unique integer number (ex. n1, n2) is used to distinguish SUPI-1 or SUPI-2.

This procedure also applies for the case when the UE has a NAS signalling connection established for SUPI-1 and the UE initiates registration procedure for the SUPI-2. In this scenarios neither the step 3 nor 4 take place but in step 5 the UE sends a RRC message including the Registration Request message, 5G-GUTI-1 or SUPI-1.

Second Aspect (Solution 2 to Solve Problem Statement 1 and 2):

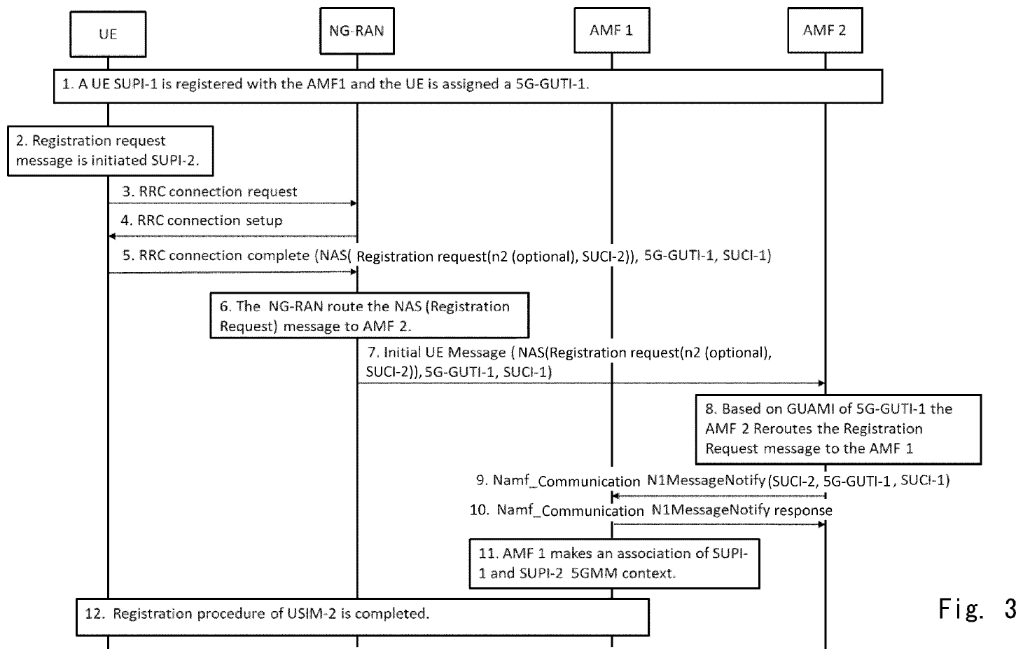

A procedure according to a second aspect includes registering all SUPIs of a UE to a Single AMF with steering done by the AMF. FIG. 3 shows the detailed steps of the procedure. The detailed steps of FIG. 3 are described below.

1. A UE is registered for a first UICC (UUSIM-1 having SUPI-1) to an AMF of a PLMN. The UE has been assigned a 5G-GUTI-1 for the first UICC.

In one example, the UE assigns a unique integer number (n1) to SUPI-1 (e.g. USIM Slot number of UICC 1 to SUPI-1). The UE sends the unique integer number assigned to SUPI-1 in registration request message or in other NAS procedure. The AMF 1 associates the SUPI-1 and the unique integer number (n1) and stores it in the UE context for SUPI-1.

2. The UE is in Idle mode i.e. does not have any NAS signalling connection with the AMF. The UE initiates registration procedure for a second UICC (USIM-2 having SUPI-2).

3. The UE sends the RRC (Connection) Setup request message to an NG-RAN in order to establish a RRC Connection.

4. The NG-RAN sends the RRC (Connection) Setup message to the UE.

5. The UE sends the RRC (Connection) Setup Complete message the NG-RAN including following parameters:

i) Registration Request message for the SUPI-2.

ii) at least one of SUCI of the first UICC 1 (SUCI-1) or 5G-GUTI of the first UICC assigned in step 1 (5G-GUTI-1).

In one example, the UE assigns a unique integer number (n2) to SUPI-2 (e.g. USIM Slot number of UICC 2 to SUPI-2). The UE sends the unique integer number assigned n2 to SUPI-2 in registration request message or in other NAS procedure.

6. The NG-RAN selects an arbitrary AMF based on an internal logic in the NG-RAN. In this flow, the AMF 2 is selected.

7. After selecting the target AMF, the NG-RAN sends the Initial UE message with Registration Request message including SUCI-2 to the selected AMF.

8. On receiving the Initial UE message with Registration Request message and 5G-GUTI-1 or SUCI-1, the AMF 2 determines a target AMF for the SUCI-2 based as follows:

i) If SUPI-1 is included in the NG-AP message then the NG-RAN finds the AMF where the UE is currently registered for SUPI-1 using SUCI-1.

In one example the NG-RAN sends SUCI-1 to the UDM or O&M entity to get the identity of the AMF (GUAMI) where the UE is registered for SUPI-1.

ii) If 5G-GUTI 1 is included in the NG-AP message then the NG-RAN selects the AMF based on the GUAMI of the 5G-GUTI-1.
iii) if both SUCI-1 and 5G-GUTI-1 are included in the NG-AP message then the

NG-RAN selects the AMF based on SUCI-1 or 5G-GUTI as described above in step 8 point i) and ii).

If the AMF internal process as listed above concludes that the 5G-GUTI-1 is accommodated in the AMF 2, then the step 9 and step 10 are skipped as there is no rerouting necessary.

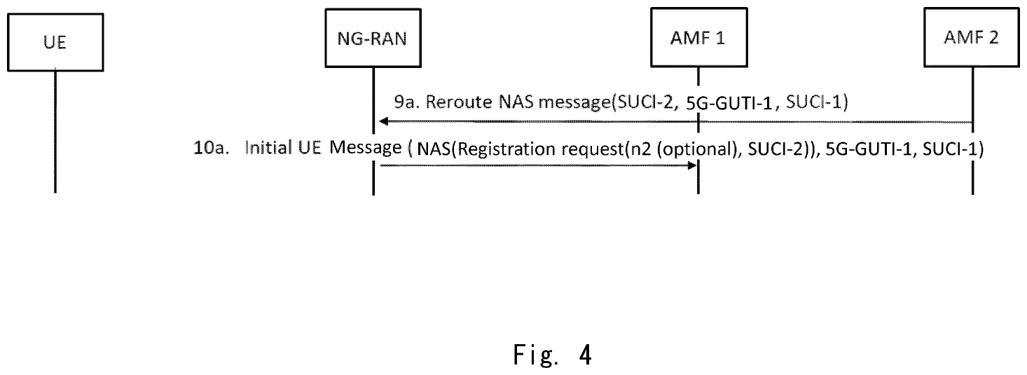

Note that either steps 9 and 10 of FIG. 3 or steps 9a and 10a of FIG. 4 take place. It is up to network configuration in accordance with NPL 3.

9. After the AMF 2 selects the target AMF 1, the AMF 2 sends the Namf_Communication N1MessageNotify message together the SUCI-2 and SUCI-1 or SUPI-1 or 5G-GUTI-1 to the AMF 1 in order to reroute the registration request message to the AMF 1.

10. The AMF 1 sends Namf_Communication N1MessageNotify response message to the AMF 2.

9a. This is another variation to make rerouting to the AMF 1. After the AMF 2 selects the target AMF 1 in step 8, the AMF 2 sends the Reroute NAS message together with SUCI-2 and SUCI-1 or 5G-GUTI-1 to the NG-RAN in order to reroute the registration request message to the AMF 1.

10a. After the NG-RAN receives the Reroute NAS message in step 9a, the NG-RAN sends the Initial UE message with Registration Request message including SUCI-2 to the selected AMF 1.

11. The AMF 1 on receiving the Namf_Communication N1MessageNotify message with SUCI-2, 5G-GUTI-1 or SUCI-1 or SUPI-1, the AMF 1 processes the registration request message for SUPI-2 and creates a context for SUPI-2. After the context creation links this 5GMM context of SUPI-2 with 5GMM context with SUPI-1, the AMF 1 makes an association between the 5GMM contexts of SUPI-1 and 5GMM Context of SUPI-2 i.e. the 5GMM contexts of SUPI-1 and SUPI-2 are linked each other. In other words, 5GMM context for SUPI-1 contains a pointer to 5GMM contest for SUPI-2 and vice versa. Using 5GMM context of SUPI-1, the 5GMM context of SUPI-2 is fetched and vice versa. The AMF 1 may also make an association between the 5GMM contexts of SUCI-1 and 5GMM Context of SUCI-2. The AMF 1 may maintain an association among multiple 5GMM contexts in case where one ME is shared by multiple USIMs.

The AMF 1 associates the SUPI-2 and the unique integer number (n2) and stores it in the UE context for SUPI-2.

12. The AMF 1 completes the registration procedure for SUPI-2.

In one example the AMF 1 assigns a single temporary identity for both SUPI-1 and SUPI-2. In this case, the unique integer number (ex. n1, n2) is used to distinguish SUPI-1 or SUPI-2.

This procedure also applies for the case when the UE has a NAS signalling connection established for SUPI-1 and the UE initiates registration procedure for the SUPI-2. In this scenarios neither the step 3 nor 4 take place but in step 5 the UE sends a RRC message including the Registration Request message, 5G-GUTI-1 or SUPI-1.

In one example the 5G-GUTI-1 or SUPI-1 is sent within the Registration Request message in steps 5 and 7.

Third Aspect (Solution 3 to Solve Problem Statement 1 and 2):

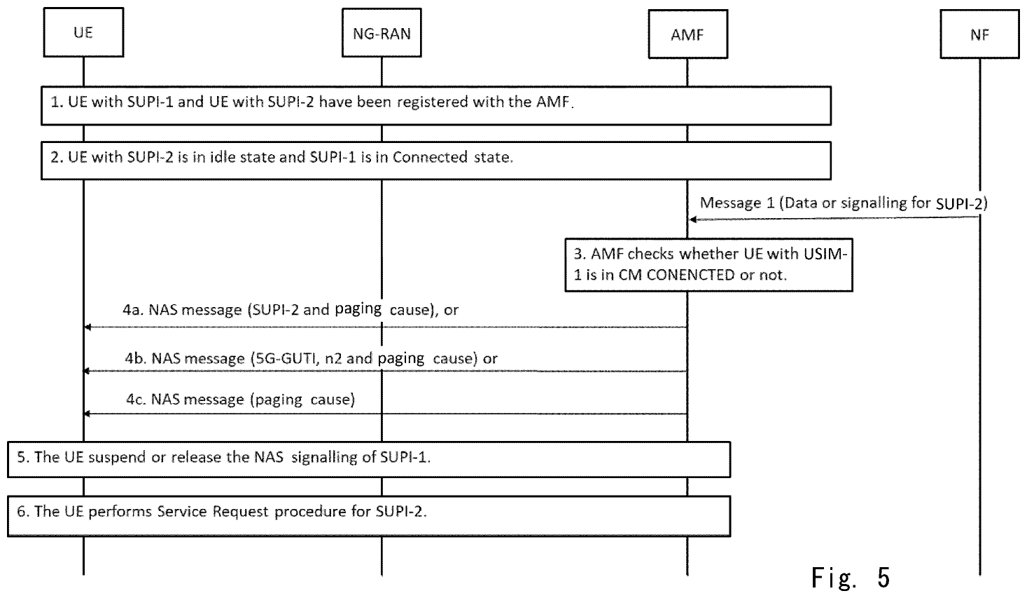

A procedure according to a third aspect includes paging co-ordination done for a SUPI using the NAS signalling connection establishment of another SUPI. FIG. 5 shows the detailed steps of the procedure. The detailed steps of FIG. 5 are described below.

1. A UE is registered to an AMF of a PLMN for SUPI-1 and SUPI-2 using either the first aspect or the second aspect.

2. The UE has established a NAS signalling connection with for SUPI-1 i.e. in 5GMM CONNECTED mode for SUPI-1 and is in 5GMM IDLE mode for SUPI-2.

3. The AMF receives, from a Network Function (NF), a message to send a signalling or data to the UE for the SUPI-2. In one example, the message to send a signalling or data to the UE for the SUPI-2 may be Namf_Communication N1N2MessageTransfer message, or the Namf_MT_EnableUEReachability message. And then, the AMF checks whether UE with USIM-1 (SUPI-1) is in CM CONNECTED or not.

One of the step 4a, 4b or 4c takes place.

4a. The AMF sends a NAS message to notify the UE about a pending Mobile Terminated signalling or date for the SUPI-2. The NAS message contains a first IE containing SUPI-2 and a second IE containing reason for notification to the UE (e.g. paging cause set to characteristics of the MT data, or MT signalling).

4b. If the UE and the AMF associate an unique integer n1 and n2 to SUPI-1 and SUPI-2 respectively during the registration procedure as per the procedure in the first aspect and the second aspect then the network includes n2 and paging cause in the NAS message. When UE receives n2 in the NAS message then it associates the NAS message with SUPI-2 based on received parameter n2.

4c. In one example the UE supports only two SUPIs then the AMF only sends paging cause in the NAS message. The UE associates the NAS message to the SUPI for which the UE is in idle state (e.g. SUPI-2) in the current scenario.

5. When a UE receives the NAS message then the UE may suspend or release the NAS signalling connection of the SUPI-1. The RRC connection may be released or may be maintained (including suspend) in this step 5.

Based on the paging cause and a service that is active for the UE with SUPI-1, the UE may not accept a requested service for the SUPI-2. For example, while UE is IMS Voice call with SUPI-1, a MT-packet service is indicated in the paging cause for SUPI-2. In this case a 2nd NAS message is sent from the UE to the AMF indicating that the notified service is not accepted by the UE. When the AMF receives the 2nd NAS message, the AMF may further informs the requested NF that the down link packet cannot be delivered to the UE due to UE busy so that the NF can take an appropriate action.

6. After the NAS signalling connection of USIM-1 is successfully suspended or released the UE initiates a service request procedure for SUPI-2. When the 5GMM state of the UE was 5GMM-IDLE Normal service for SUPI-2, when the NAS message was received or registration procedure, when a registration procedure is pending for the SUPI-2, the UE performs the procedure. The service request procedure for SUPI-2 can be done with maintained RRC connection in step 5.

In one example when the UE is idle state for both SUPI-1 and SUPI-2, the UE runs Periodic Update Timers (PUT) for both SUPI-1 and SUPI-2 and the AMF runs Mobile Reachable Timers (MRT) for SUPI-1 and SUPI-2. When a NAS signalling connection is established for one SUPI then the UE and the AMF stop PUT and MRT for both SUPI-1 and SUPI-2. Both the UE and the AMF keeps the 5GMM context for the SUPI-2 which is in 5GMM IDLE state. When the UE's state change to idle state in the UE and the AMF for both SUPI-1 and SUPI-2, the UE and the AMF starts the MRT and PUT for both SUPI-1 and SUPI-2.

In one example, when the UE is idle state for both SUPI 1 and SUPI 2, the UE runs Periodic Update Timers (PUT) for both SUPI-1 and SUPI-2 and the AMF runs Mobile Reachable Timers (MRT) for SUPI-1 and SUPI-2. When a NAS signalling connection is established for SUPI-1 then the UE and the AMF keep running the PUT and MRT for the second SUPI-2 which is in idle state. When the PUT of the SUPI-2 expires then it performs the Periodic update procedure using the NAS signalling connection of the SUPI-1 by sending a NAS message indicating periodic update of SUPI-2 (e.g. Registration Request message with registration type periodic, or the NAS message is an existing NAS message or a new NAS message).

In one example when the UE and the AMF runs a single PUT and MRT timer for both SUPI-1 and SUPI-2, when the periodic timer expires the UE sends a single periodic registration request message to the AMF for both SUPI-1 and SUPI-2. The AMF on receiving the registration request message stops the MRT and updates that both SUPI-1 and SUPI-2 are registered to the AMF. On the expiry of MRT the AMF marks that the UE is not reachable for paging. The AMF may de-registers both SUPI-1 and SUPI-2 after the expiry of MRT.

In one example the NAS message can be a NOTIFICATION message or a DL NAS TRANSPORT message.

In one example the 2nd NAS message can be a NOTIFICATION RESPONSE message, or a UL NAS TRANSPORT message.

Forth Aspect (Solution 4 to Solve Problem Statement 1 and 2):

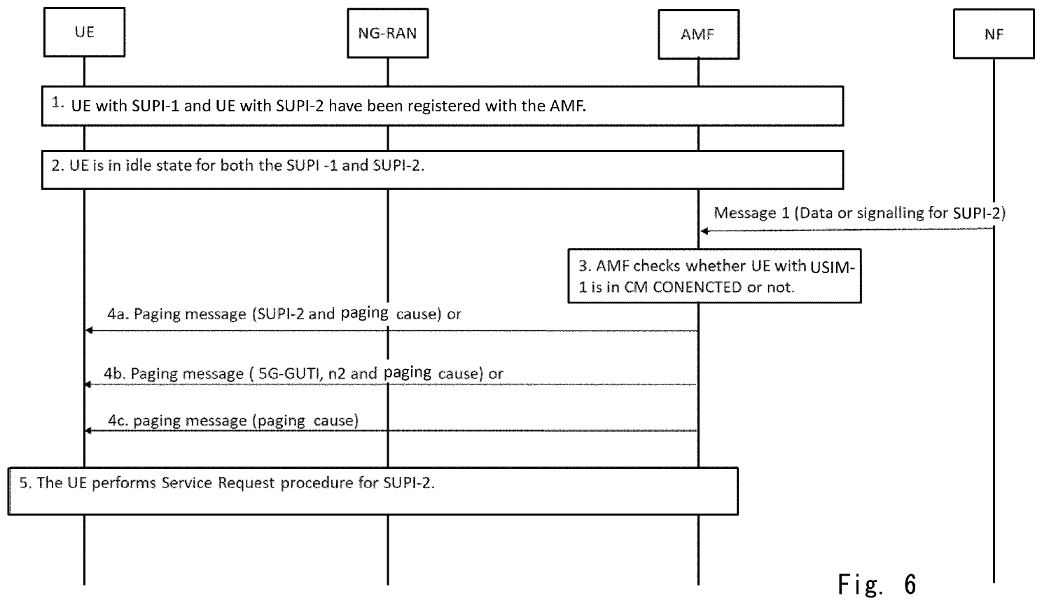

A procedure according to a forth aspect includes paging co-ordination done in the idle mode using same temporary identity assigned to the both SUPI-1 and SUPI-2. FIG. 6 shows the detailed steps of the procedure. The detailed steps of FIG. 6 are described below.

1. The UE and the AMF perform the registration procedure as per the first aspect or the second aspect. The network assigns an identical temporary identity (e.g. a 5G-GUTI) to both SUPI-1 and SUPI-2.

2. The UE and the AMF are in idle mode for both SUPI-1 and SUPI-2.

3. The AMF receives, from a Network Function (NF), a message to send a signalling or data to the UE for the SUPI-2. In one example, the message to send a signalling or data to the UE for the SUPI-2 may be Namf_Communication N1N2MessageTransfer message, or the Namf_MT_EnableUEReachability message. And then, the AMF checks whether UE with USIM-1 (SUPI-1) is in CM CONNECTED or not.

4. The AMF initiates a paging procedure to SUPI-2 by sending a NGAP paging message containing paging cause, the temporary identity (e.g. 5G-GUTI) and n2. The NG-RANs perform a paging containing paging cause, the temporary identity and n2.

Although step 4a, 4b and 4c are shown in FIG. 6 with one lines each from the AMF to the UE for simplicity reason, each line can be split into two parts, one over the N2 interface between the AMF and NG-RANs and the other one over the air interface between the NG-RAN and the UE.

5. When the UE receives paging message then the UE determines that the paging is for the UE based on the temporary identity and for the SUPI-1 based n2.

6. The UE initiates the service request with 5G-GUTI with n2 when the UE is in idle state and camps normally on the cell or registration procedure when the UE requires registration procedure.

Fifth Aspect (Solution 5 to Solve Problem Statement 1 and 2):

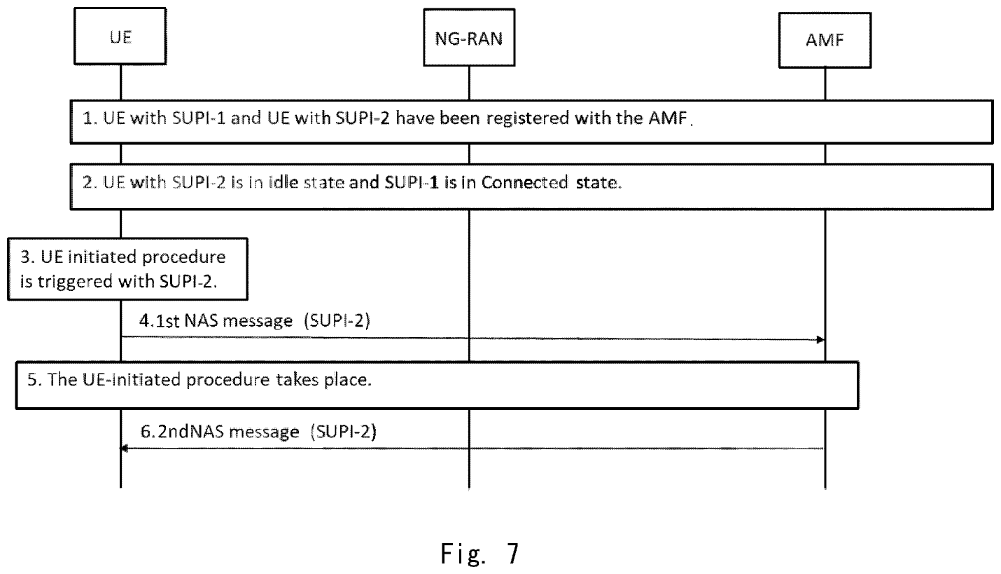

A procedure according to a fifth aspect includes UE initiated procedure for a SUPI using the NAS signalling connection establishment of another SUPI. FIG. 7 shows the detailed steps of the procedure. The detailed steps of FIG. 7 are described below.

1. A UE is registered to an AMF of a PLMN for SUPI-1 and SUPI-2 using either the first aspect or the second aspect.

2. The UE has established a NAS signalling connection with for SUPI-1 i.e. in 5GMM CONNECTED mode for SUPI-1 and is in 5GMM IDLE mode for SUPI-2.

3. The UE initiates the UE initiated procedure with SUPI-2.

4. The UE sends a 1st NAS message for SUPI-2. The 1st NAS message contains a SUPI-2.

In one example the 1st NAS message for SUPI-2 is NAS security protected (ciphered or integrity protected) with the NAS security context of SUPI-2.

In one example the 1st NAS message for SUPI-2 is NAS security protected (ciphered or integrity protected) with the NAS security context of SUPI-1.

In one example UE uses the AS layer security context of SUPI-1 at the AS layer.

5. The UE initiated procedure takes place.

6. The AMF sends a 2nd NAS message to the UE. The 2nd NAS message contains a SUPI-2.

In one example the 1st NAS message can be a Registration request message, Registration Compete message, Deregistration request message or a UL NAS TRANSPORT.

In one example the 2nd NAS message can be a Reregistration response message, Deregistration response message or a DL NAS TRANSPORT message.

In one example, the UE initiated procedure can be a Registration procedure, UE-initiated de-registration procedure, an MO SMS over NAS procedure or a UE-initiated NAS transport procedure.

In one example the 2nd NAS message for SUPI-2 is NAS security protected (ciphered or integrity protected) with the NAS security context of SUPI-2.

In one example the 2nd NAS message for SUPI-2 is NAS security protected (ciphered or integrity protected) with the NAS security context of SUPI-1.

In one example UE uses the AS layer security context of SUPI-1 at the AS layer.

In one example the 1st NAS message or 2nd NAS message is sent standalone i.e. without encapsulating in any NAS message of SUPI-1.

In one example the 1st NAS message is encapsulated in the UL NAS TRANSPORT message of SUPI-1.

In one example the 2nd NAS message is encapsulated in the DL NAS TRANSPORT message of SUPI-1.

Another Aspect:

The User Equipment (or “UE”, “mobile station”, “mobile device” or “wireless device”) in the present disclosure is an entity connected to a network via a wireless interface.

It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 1 (source: 3GPP TS 22.368 V14.0.1 (2017-08), Annex B, the contents of which are incorporated herein by reference). This list is not exhaustive and is intended to be indicative of some examples of machine type communication applications.

TABLE 1
Some examples of machine-type communication applications.

| Service Area | MTC applications |
|---|---|
| Security | Surveillance systems |
| | Backup for landline |
| | Control of physical |
| | access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic |
| | optimisation/steering |
| Payment | Point of sales |
| | Vending machines |
| | Gaming machines |
| Health | Monitoring vital signs |
| | Supporting the aged |
| | or handicapped |
| | Web Access |
| | Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary aspects described in the present document. Needless to say, these technical ideas and aspects are not limited to the above-described UE and various modifications can be made thereto.

User Equipment (UE)

In all above aspects, a UE consists of a ME more than one UICCs or USIM or eUSIM (embedded USIM). In addition to FIG. 1, general block diagram of the UE is explained here.

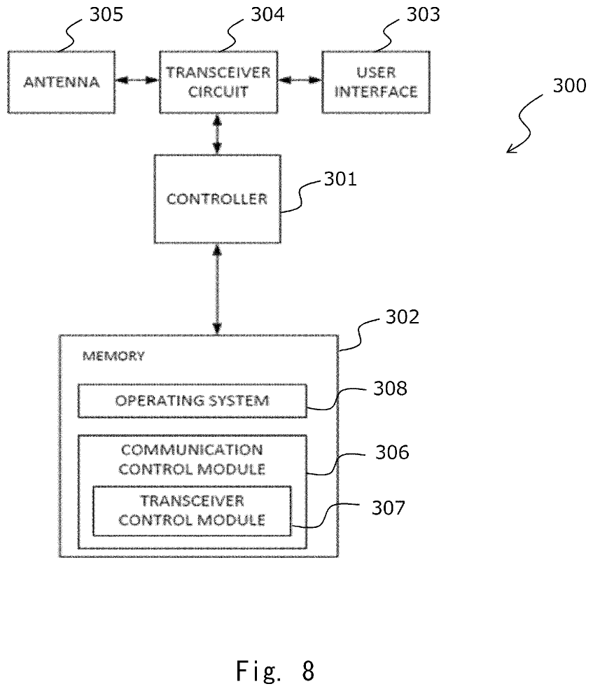

FIG. 8 is a block diagram illustrating the main components of the UE 300. As shown, the UE 300 includes a transceiver circuit 304 which is operable to transmit signals to and to receive signals from the connected node(s) via one or more antenna 305. Although not necessarily shown in FIG. 8, the UE 300 will of course have all the usual functionality of a conventional mobile device (such as a user interface 303) and this may be provided by any one or any combination of hardware, software and firmware, as appropriate. Software may be pre-installed in the memory 302 and/or may be downloaded via the telecommunication network or from a removable data storage device (RMD), for example.

A controller 301 controls the operation of the UE 300 in accordance with software stored in a memory 302. For example, the controller 301 may be realized by Central Processing Unit (CPU). The software includes, among other things, an operating system 308 and a communications control module 306 having at least a transceiver control module 307. The communications control module 306 (using its transceiver control sub-module) is responsible for handling (generating/sending/receiving) signalling and uplink/downlink data packets between the UE 300 and other nodes, such as the base station/(R)AN node, a MME, the AMF (and other core network nodes). Such signalling may include, for example, appropriately formatted signalling messages relating to connection establishment and maintenance (e.g. RRC messages), NAS messages such as periodic location update related messages (e.g. tracking area update, paging area updates, location area update) etc.

(R)AN Node

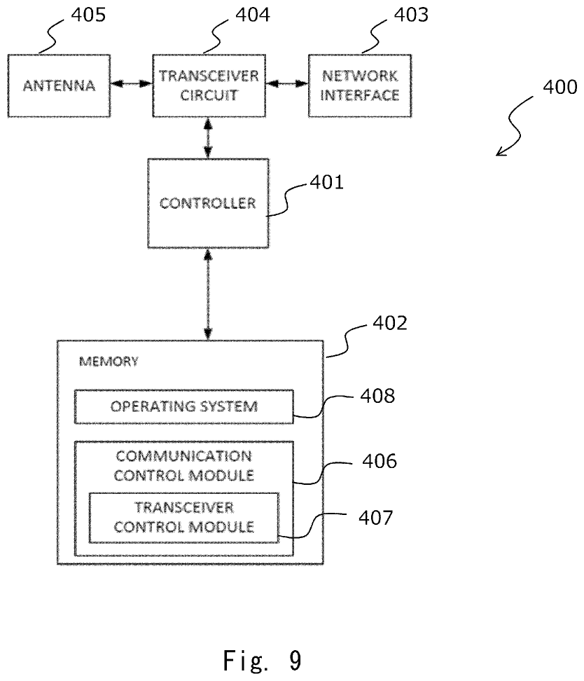

FIG. 9 is a block diagram illustrating the main components of an exemplary (R)AN node 400, for example a base station (‘eNB’ in LTE, ‘gNB’ in 5G). As shown, the (R)AN node 400 includes a transceiver circuit 404 which is operable to transmit signals to and to receive signals from connected UE(s) via one or more antenna 405 and to transmit signals to and to receive signals from other network nodes (either directly or indirectly) via a network interface 403. A controller 401 controls the operation of the (R)AN node in accordance with software stored in a memory 402. For example, the controller 401 may be realized by Central Processing Unit (CPU). Software may be pre-installed in the memory 402 and/or may be downloaded via the telecommunication network or from a removable data storage device (RMD), for example. The software includes, among other things, an operating system 408 and a communications control module 406 having at least a transceiver control module 407.

The communications control module 406 (using its transceiver control sub-module) is responsible for handling (generating/sending/receiving) signalling between the (R)AN node 400 and other nodes, such as the UE, the MME, the AMF (e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller 401 is also configured (by software or hardware) to handle related tasks such as, when implemented, UE mobility estimate and/or moving trajectory estimation.

AMF

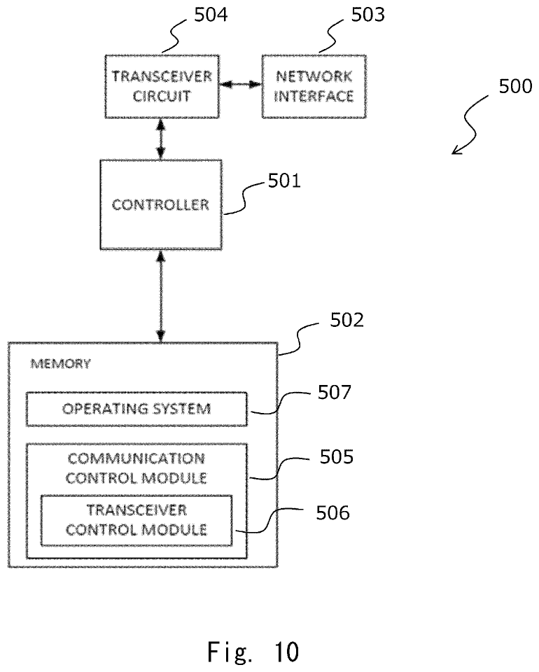

FIG. 10 is a block diagram illustrating the main components of the AMF 500. The AMF 500 is included in the 5GC. As shown, the AMF 500 includes a transceiver circuit 504 which is operable to transmit signals to and to receive signals from other nodes (including the UE) via a network interface 503. A controller 501 controls the operation of the AMF 500 in accordance with software stored in a memory 502. For example, the controller 501 may be realized by Central Processing Unit (CPU). Software may be pre-installed in the memory 502 and/or may be downloaded via the telecommunication network or from a removable data storage device (RMD), for example. The software includes, among other things, an operating system 507 and a communications control module 505 having at least a transceiver control module 506.

The communications control module 505 (using its transceiver control sub-module) is responsible for handling (generating/sending/receiving) signalling between the AMF 500 and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

As will be appreciated by one of skill in the art, the present disclosure may be embodied as a method, and system. Accordingly, the present disclosure may take the form of an entirely hardware aspect, a software aspect or an aspect combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from Indian patent applications No. 201841049571, filed on Dec. 28, 2018, the disclosure of which is incorporated herein in its entirety by reference.

### REFERENCE SIGNS LIST

100 UE
101 antenna
102 ME
103 transmitter
104 receiver
105 USIM
300 UE
301 controller
302 memory
303 user interface
304 transceiver circuit
305 antenna
306 communication control module
307 transceiver control module
308 operating system
400 (R)AN node
401 controller
402 memory
403 network interface
404 transceiver circuit
405 antenna
406 communications control module
407 transceiver control module
408 operating system
500 AMF
501 controller
502 memory
503 network interface
504 transceiver circuit
505 communications control module
506 transceiver control module
507 operating system

1. A method for a network apparatus, the method comprising:
receiving, from a User Equipment (UE) that includes a first Universal Subscriber Identity Module (USIM) having a first Subscription Permanent Identifier (SUPI) registered with an Access and Mobility Management Function (AMF) and a second USIM having a second SUPI, a message including a Registration Request for the second SUPI,
determining a target AMF based on the Registration Request for the second SUPI, and
sending, to the target AMF, a message including the Registration Request for the second SUPI.

2. A method for a network apparatus, the method comprising:
registering a first Subscription Permanent Identifier (SUPI) for a first Universal Subscriber Identity Module (USIM) included in a User Equipment (UE) and a second SUPI for a second USIM included in the UE,
receiving, from a Network Function (NF), a message to send a signaling or data to the UE for the second SUPI, and
paging the UE to send the signaling or data for the second SUPI.

3. A method for a User Equipment (UE), the method comprising:
registering with an Access and Mobility Management Function (AMF) a first Subscription Permanent Identifier (SUPI) for a first Universal Subscriber Identity Module (USIM) included in the UE and a second SUPI for a second USIM included in the UE,
initiating a UE initiated procedure with the second SUPI,
sending, to the AMF, a first message for the second SUPI,
performing the UE initiated procedure, and
receiving, form the AMF, a second message for the second SUPI.
